(19) United States
(12) Patent Application Publication
(10) Pub. No.: US 2024/0277187 A1
(43) Pub. Date: Aug. 22, 2024

(54) COMBINATION DRESSING AND SEASONING DISPENSER

(71) Applicant: Kitchinventions LLC, Jupiter, FL (US)

(72) Inventor: Derek Monk, Jupiter, FL (US)

(21) Appl. No.: 18/437,397

(22) Filed: Feb. 9, 2024

Related U.S. Application Data
(60) Provisional application No. 63/485,554, filed on Feb. 17, 2023.

(51) Int. Cl. A47J 47/01; A47J 42/38

(52) U.S. Cl. CPC A47J 47/01; A47J 42/38

(57) ABSTRACT

A combination dressing and seasoning dispenser includes an upper section removably attached to a lower section. Each of the sections includes its own internal storage area. The upper sections includes a spout and the lower section is partially open. In one example the upper section stores liquid to be poured from the spout and the lower section is a mill that stores seasoning for grinding and dispensing.

### CROSS REFERENCE TO RELATED APPLICATIONS

This application claims the benefit of U.S. Provisional Application No. 63/485,554 filed on Feb. 17, 2023.

### BRIEF DESCRIPTION OF THE DRAWINGS

FIG. 1 is a perspective view of the dispenser.

FIG. 2 is a perspective exploded view of the dispenser

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

### DETAILED DESCRIPTION OF THE INVENTION

In the following description, for the purposes of explanation, numerous specific details are set forth in order to provide a thorough understanding of the dispenser of the present invention. It will be apparent, however, to one skilled in the art that the dispenser may be practiced without some of these specific details. Throughout this description, the embodiments and examples shown should be considered as exemplars, rather than as limitations on the dispenser. That is, the following description provides examples, and the accompanying drawings show various examples for the purposes of illustration. However, these examples should not be construed in a limiting sense as they are merely intended to provide examples of the dispenser rather than to provide an exhaustive list of all possible implementations of the dispenser.

Specific embodiments of the invention will now be further described by the following, non-limiting examples which will serve to illustrate various features. The examples are intended merely to facilitate an understanding of ways in which the invention may be practiced and to further enable those of skill in the art to practice the invention. Accordingly, the examples should not be construed as limiting the scope of the invention. In addition, reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

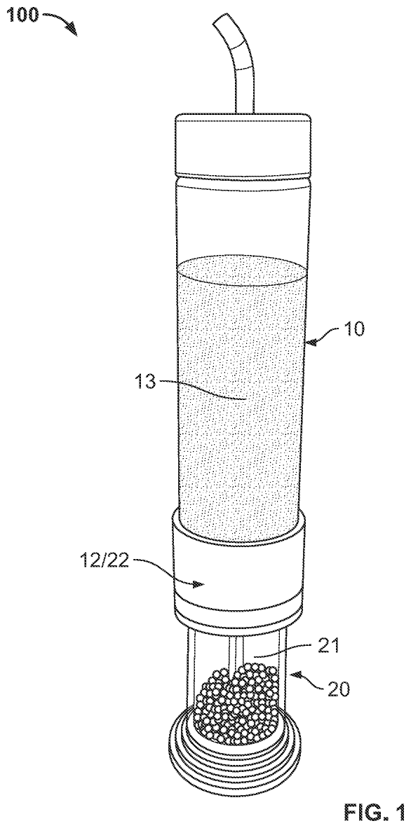

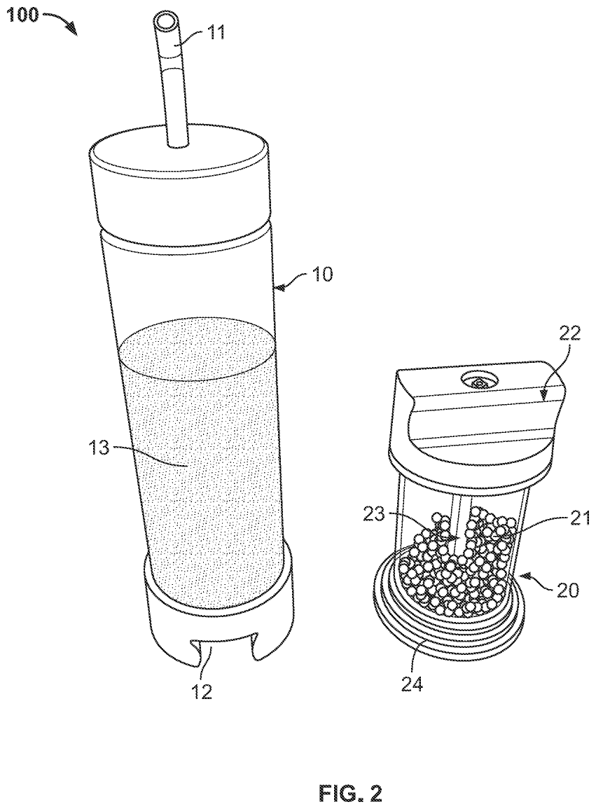

Referring to FIGS. 1-2, shown is a dispenser 100 comprising an upper section 10 and a lower section 20, each with its own separate internal storage area. The upper section 10 is configured to retain and dispense an ingredient such as oil, vinegar, or other desired dressing, sauce, or topping. Upper section 10 includes an internal storage area 13 wherein the desired ingredient is retained and stored. The distal end 11 of the upper section 10 includes or comprises an opening or partial opening such as a spout from which the contents of the upper section 10 are dispensed. Other caps, covers, and dispensing mechanisms may be employed, such as stoppers, screw-on caps, measuring dispensers, fluted spouts, and the like.

Lower section 20 is configured to retain and dispense an ingredient such as salt, pepper, or other desired herbs or spices. The distal end 22 of the lower section 20 includes or comprises an opening or partial opening from which the contends of the lower section 20 are dispenses. The lower section 20 includes an internal storage area 21 wherein the desired ingredient is retained and stored. In some embodiments, the internal storage area 21 includes a grinding mechanism 23 which is attached to the distal end 24. The grinding mechanism can be configured as a “pepper-mill”known in the art. The distal end 24, therefore, rotates in order to rotate the grinding mechanism 23 to grind or pulverize the ingredient, which ingredient then exits from the at least partially opening at the distal end 24. In some embodiments, the grinding mechanism 23 is integral with the distal end 24 and need not extend into the internal storage area 21 of the lower section 20. In other embodiments, the distal end 24 can comprise a perforated or other partially-open configuration to allow ingredients and particular to be dispensed therefrom. In some embodiments, a cap or cover is provided to removably seal the distal end 24 of the lower section 20.

The upper section 10 and lower section 20 are coupled and removably attached to other another at their respective proximal ends. In some embodiments, the proximal end of the upper section 10 includes a groove 12 that is sized, orientated, and configured to receive a tongue 22 disposed on the proximal end of the lower section 20. In this embodiment, the tongue 22 slides into the groove 12 such that the upper section 10 and lower section 20 are removably secured to one another to form a unitary dispenser device. Other attachment systems, methods, and means may be employed to removably connect the respective proximal ends of the upper section 10 and lower section 20 including a threaded connection, a snap-fit connection, an interference fit connection, a rotating slot-and-groove connection, a magnetic connection, and the like. With this configuration it is noted that the upper section 10 is refillable by opening the distal end 11 thereof whereas the lower section 20 can be refilled by opening the distal end 24 or the proximal end of the lower section 20 (where 22 points) thereof.

It is appreciated that the dispenser 100 provides a simple and elegant solution to storing and accessing dressings, seasonings, condiments, spices, and the like in a single usable package. The dispenser 100 is designed so that the user can access and dispense ingredients from both the upper section 10 and lower section 20 without separating the two sections given that the distal ends of both are opposing and both exposed when the dispenser 100 is in a “one-piece” configuration. This conserves counter space and also makes the device easier to handle because the dispenser provides the feel of a larger grinder but offers the additional functionality of a liquid/dressing dispenser Alternatively, the upper section 10 can be separated from the lower section 20 to allow for access to the ingredients separately.

It is to be noticed that the term “comprising,” used in the claims, should not be interpreted as being limitative to the means listed thereafter. Thus, the scope of the expression “a device comprising means A and B” should not be limited to devices consisting only of components A and B. It means that with respect to the present invention, the only relevant components of the device are A and B. Put differently, the terms “including”, “comprising” and variations thereof mean “including but not limited to”, unless expressly specified otherwise.

Similarly, it is to be noticed that the term “coupled”, also used in the claims, should not be interpreted as being limitative to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

The enumerated listing of items does not imply that any or all of the items are mutually exclusive, unless expressly specified otherwise. The terms “a”, “an” and “the” mean “one or more”, unless expressly specified otherwise.

Elements of the invention that are in communication with each other need not be in continuous communication with each other, unless expressly specified otherwise. In addition, elements of the invention that are in communication with each other may communicate directly or indirectly through one or more other elements or other intermediaries.

One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that any alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A dispenser, comprising:
an upper section removably attached to a lower section;
wherein each of the upper section and the lower section has a separate internal storage area; and
wherein each of the upper section and the lower section includes a distal end from where an ingredient stored in the respective internal storage area is dispensed.

2. The dispenser of claim 1, wherein the distal end of the upper section includes a spout.

3. The dispenser of claim 2, wherein the lower section includes a grinding mechanism and the distal end thereof is at least partially open.

4. The dispenser of claim 1, wherein each of the upper and lower sections are refillable.

5. The dispenser of claim 1, wherein the upper section is removably attached to the lower section by a tongue and grove connection.

6. The dispenser of claim 1, wherein the upper section is removably attached to the lower section by a threaded connection.

7. The dispenser of claim 1, wherein the upper section is removably attached to the lower section by a magnetic connection.

8. The dispenser of claim 1, wherein the upper section is removably attached to the lower section by an interference fit.

9. The dispenser of claim 1, wherein the upper section is removably attached to the lower section by a rotating slot and groove connection.
